(19) United States
(12) Patent Application Publication
(10) Pub. No.: US 2014/0016887 A1
(43) Pub. Date: Jan. 16, 2014

(54) BEARING BRACKET AND SYSTEM FOR A MACHINE

(71) Applicants: Stephen Joel DeBlock, Peterborough (CA); Michael Benjamin DeBlock, Peterborough (CA); Rajesh Poddaturi, Hyderabad (IN)

(72) Inventors: Stephen Joel DeBlock, Peterborough (CA); Michael Benjamin DeBlock, Peterborough (CA); Rajesh Poddaturi, Hyderabad (IN)

(73) Assignee: GENERAL ELECTRIC COMPANY, Schenectady, NY (US)

(21) Appl. No.: 13/546,192

(22) Filed: Jul. 11, 2012

(51) Int. Cl. F16M 13/02; F16C 33/00

(52) U.S. Cl. 384/91; 248/309.1

(57) ABSTRACT

A bearing system for a machine includes a bearing housing configured to constrain motion of a part within the machine, the bearing housing having a substantially circular cross-sectional shape. The bearing system also includes a bearing bracket configured to secure the bearing housing to the machine, the bearing bracket formed to cover more than a half and less than all of the circular cross-sectional shape of the bearing housing.

### BACKGROUND OF THE INVENTION

The subject matter disclosed herein relates to bearing bracket (end shield) design.

In a machine with a moving part, a bearing housing constrains relative motion between that part and the remainder of the machine, as needed. A bearing bracket is used to support the bearing housing and hold it in place and also support a rotating shaft. While the most effective bearing bracket would seem to be one that completely covers the bearing housing (a full-circle bracket covering a bearing housing with a circular cross-sectional shape, for example), such a bearing bracket does not allow easy access to the machine when built as a single piece and does not provide the maximum support when formed as more than one piece for ease of access. In prior systems, bearing brackets formed as half-circles to cover a bearing housing with a circular cross-sectional shape have been used to provide easy access to the machine. However, these bearing brackets provide insufficient support, especially as the size of machines and their requisite bearing housings increase.

### BRIEF DESCRIPTION OF THE INVENTION

According to one aspect of the invention, a bearing system for a machine includes a bearing housing configured to constrain motion of a part within the machine, the bearing housing having a substantially circular cross-sectional shape; and a bearing bracket configured to secure the bearing housing to the machine, the bearing bracket formed to cover more than a half and less than all of the circular cross-sectional shape of the bearing housing.

According to another aspect of the invention, a bearing bracket supporting a bearing housing in a machine, the bearing bracket includes material formed with a cross-sectional perimeter formed by two concentric arcs having a same central angle and being connected by segments of radial lines that define each end of the arcs; and a stiffener comprised of two or more braces in a first direction and alternating hollow portions, the two or more braces in the first direction being connected by a pair of braces in a second directions.

According to yet another aspect of the invention, a bearing bracket for affixing a bearing in a machine includes material formed with a cross-sectional shape of a circle with a slot removed; and a stiffener comprised of two or more braces in a first direction and alternating hollow portions, the two or more braces in the first direction being connected by a pair of braces in a second direction.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective front view of a bearing system of a machine according to an embodiment of the invention;

FIGS. 2 and 3 depict perspective front views of a bearing bracket according to an embodiment of the invention;

FIGS. 4 and 5 depict perspective views of a bearing bracket for an end flange bearing housing;

FIG. 6 depicts an integral bearing bracket and housing according to an embodiment of the invention;

FIG. 7 is a perspective back view of the bearing bracket according to the embodiment shown by FIG. 2;

FIG. 8 is a perspective back view showing details of the inboard stiffener of a bearing bracket according to an embodiment of the invention;

FIG. 9 is a perspective front view of a bearing bracket according to an embodiment of the invention;

FIG. 10 is a perspective back view of the bearing bracket according to the embodiment shown by FIG. 9; and

FIGS. 11 and 12 are perspective side views of the bearing bracket according to embodiments of the invention.

The detailed description explains embodiments of the invention, together with advantages and features, by way of example with reference to the drawings.

### DETAILED DESCRIPTION OF THE INVENTION

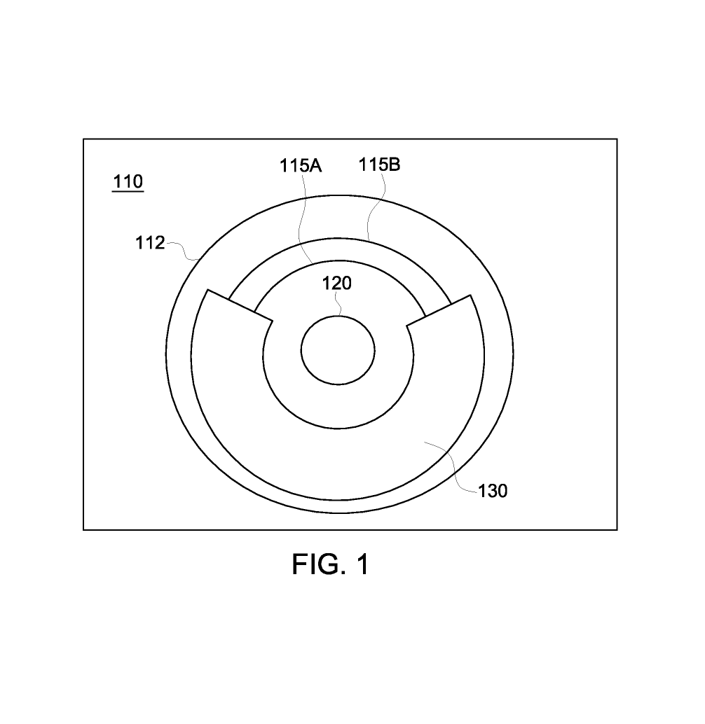

FIG. 1 is a perspective front view of a bearing system (bearing housing 120, bearing bracket 130) of a machine 110 according to an embodiment of the invention. The machine 110 may be, for example, an electric motor or generator. However, embodiments of the bearing system are compatible with any rotating machinery using any type of bearing to support a rotating part and the embodiments discussed herein are not limited for use with any one exemplary machine 110. Other exemplary machines 110 include electric motors, electric generators, synchronous condensers and other dynamoelectric machines, pumps, gearboxes, and gas turbine engines. Exemplary bearing types include, but are not limited to, fluid film bearings (hydrodynamic bearing types), anti-friction, or magnetic bearings. For an exemplary machine 110 being an electric motor, two parts 115 (the rotor 115a and the stator 115b, with windings not detailed) are shown within an opening 112 of the machine 110. The bearing housing 120 constrains the movement of a part 115 (rotor 115a in the exemplary case of the electric motor). While the bearing housing 120 is used to constrain movement of the part 115a, the bearing bracket 130 is used to support the bearing housing 120.

A potential problem introduced by any bearing bracket (e.g., the bearing bracket 130) stems from its natural frequency. If the electrical line and rotational frequencies of the machine 110 are not sufficiently separate from the natural frequency of the bearing bracket 130, then the bearing bracket 130 can be excited by the operational frequencies of the machine 110 and introduce noise and structural resonance at various subsynchronous and supersynchronous frequencies within the machine 110. Because the natural frequency of any bearing bracket (e.g., the bearing bracket 130) is a function of its stiffness and mass, and because increased mass can be a consequence of increased stiffness, the design of the bearing bracket 130 according to embodiments of the invention balances the two parameters in order to provide a sufficient separation margin between the machine 110 frequency and the natural frequency of the bearing bracket 130.

For example, the bearing bracket 130 according to an embodiment of the present invention may provide a separation margin of 15% or more between its natural frequency and the operating frequency of the machine 110. The bearing bracket 130 shown at FIG. 1 may increase stiffness while maintaining, if not increasing, stiffness-to-mass ratio from previous designs (such as the half-circle design) and also allowing access to the machine 110. The natural frequency of the bearing bracket 130 shown at FIG. 1 may be, for example, 75 Hz. This natural frequency may provide at least 25% separation margin from the machine 110 operating and twice operating frequencies and 25% separation margin from the electrical line frequency.

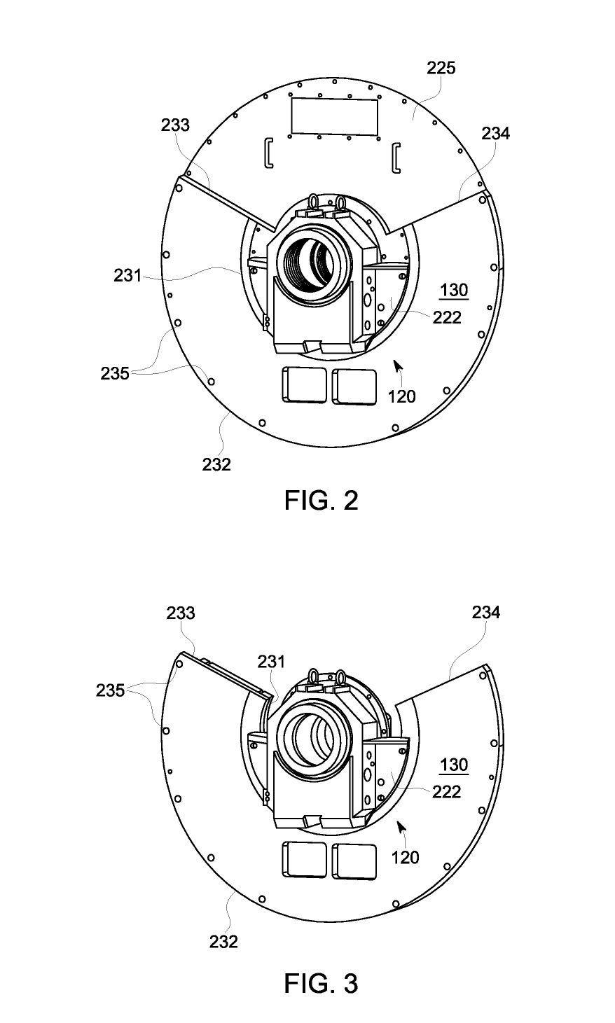

FIGS. 2 and 3 are perspective front views of a bearing bracket 130 according to an embodiment of the invention. FIG. 2 shows the bearing bracket 130 with the cover 225 and FIG. 3 shows the bearing bracket 130 without a cover. The bearing bracket 130 of the present embodiment has a cross-sectional shape defined by two concentric arcs (231 and 232) that have the same central angle and that are connected by a segment of the radial lines (233, 234) that define the two ends of the arcs. The central angle of the arcs may be between 180-360 degrees. The cover 225 (FIG. 2) may be removed (as in FIG. 3) to access the machine 110.

The embodiments shown at FIGS. 2 and 3 include a center flange 222 mounted bearing housing 120. Because of the opening in the bearing bracket 130, it can be used with a center flange 222 mounted bearing housing 120. That is, the bearing bracket 130 may be placed in partially circular contact with the bearing housing 120. While bolt holes 235 are shown at the perimeter of the bearing bracket 130 as an exemplary means of affixing the bearing bracket 130 to the machine 110 frame, the bearing bracket 130 is contemplated to be affixed to the frame of the machine 110 in all of the ways known in the art. Because the bearing bracket 130 may only be affixed to the frame of the machine 110 at the bearing bracket 130 perimeter, the unattached inner portion of the bearing bracket 130 is susceptible to vibration, thereby requiring that the bearing bracket 130 to be sufficiently stiff and to have sufficient separation of natural frequency from the operating frequency of the machine 110.

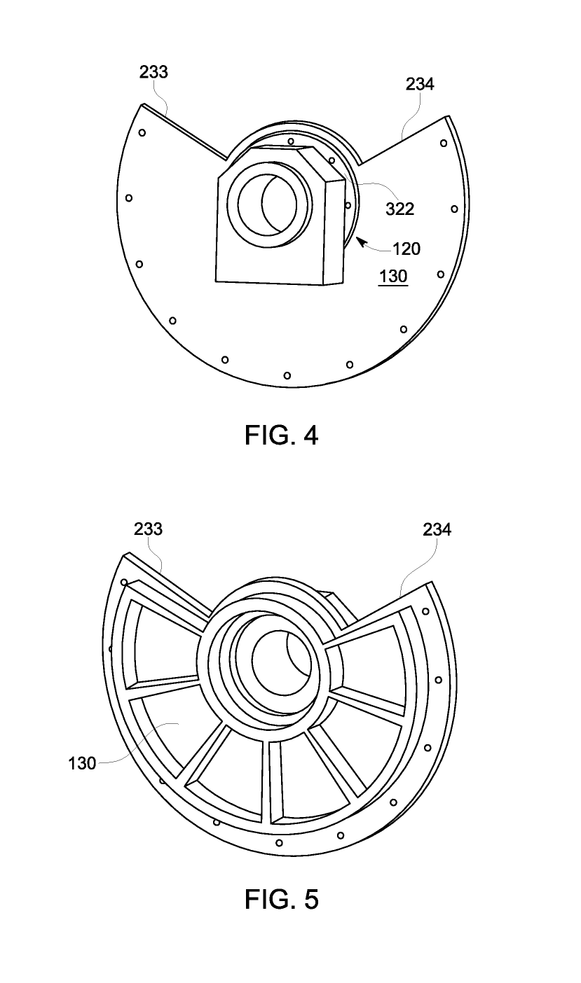

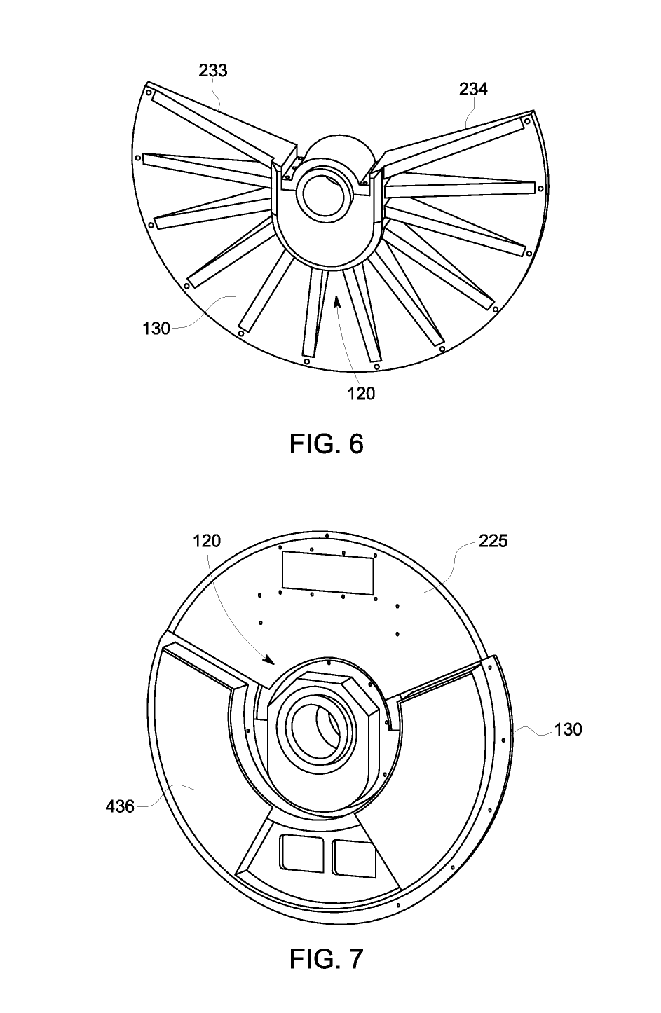

FIGS. 4 and 5 depict perspective views of a bearing bracket 130 for an end flange 322 mounted bearing housing 120 according to embodiments of the invention. That is, the bearing bracket 130 may have contact with the bearing housing 120 over a full circle as shown by FIG. 4. FIG. 4 shows a front view of the bearing bracket 130 and end flange 322 mounted bearing housing 120. FIG. 5 shows a back view of the bearing bracket 130 of FIG. 4. FIG. 6 depicts an integral bearing bracket 130 and housing 120 according to an embodiment of the invention. As illustrated by FIG. 4, the design of the bearing bracket 130 and, specifically, the opening (between the radial lines 233, 234), allows its use with both the end flange 322 and center flange 222 (FIGS. 2 and 3) mounted bearing housing 120.

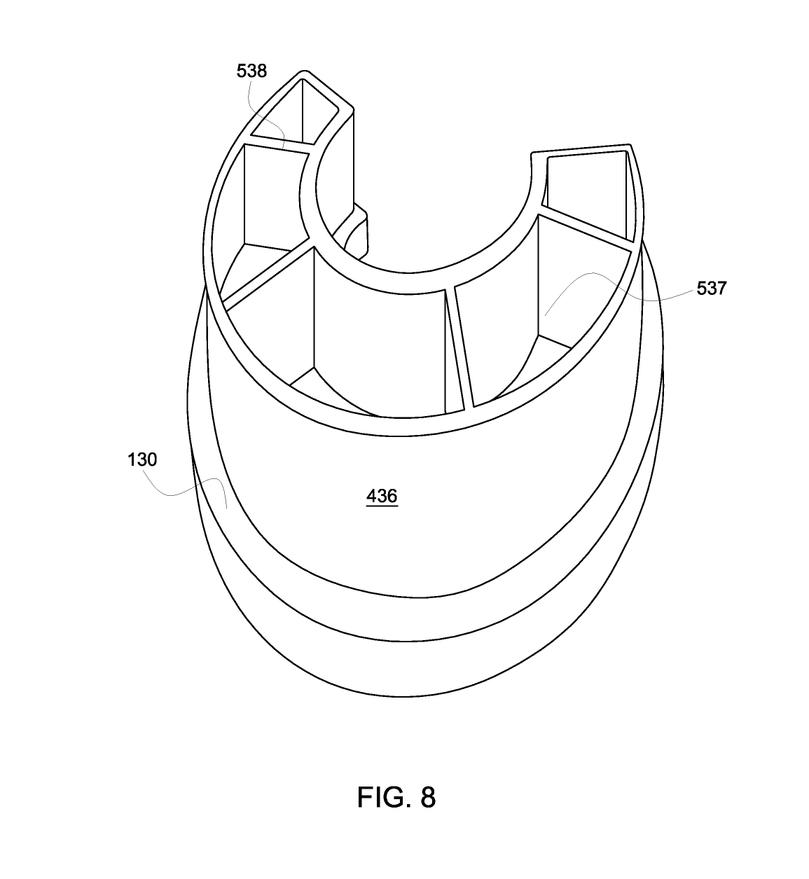

FIG. 7 is a perspective back view of the bearing bracket 130 according to the embodiment shown by FIGS. 2 and 3. In particular, the view shown by FIG. 7 includes a cover 225 as in FIG. 2. The back view shows the stiffener 436 built into the bearing bracket 130. Additional axial stiffness is achieved by the bearing bracket 130 (over the half-circular bearing bracket, for example) for two reasons: because the increased outer edge of the bearing bracket 130 that becomes affixed to the frame of the machine 110 increases the ability of the bearing bracket 130 to resist axial deflection at the inner edge, and because additional space is available for the inboard stiffener 436 (detailed in FIG. 8). The stiffener 436 shown at FIG. 7 is uncovered in a middle portion. In alternate embodiments, different portions of the stiffener 436 may be covered or uncovered. Horizontal and vertical stiffness of the bearing bracket 130 is increased.

FIG. 8 is a perspective back view showing details of the inboard stiffener 436 of a bearing bracket 130 according to an embodiment of the invention. Because of the design, which includes hollow portions 537, the stiffener 436 allows stiffness of the bearing bracket 130 to be increased while increasing or at least maintaining stiffness-to-mass ratio. In addition, protrusion of the stiffener 436 into the machine 110 (depth of the braces 538) is reduced because, with the increased area and angle of coverage, a greater number of braces 538 with decreased depth may be used for enhanced stiffness of the bearing bracket 130 when compared to, for example, the half-circle bearing bracket of previous designs. That is, the stiffener 436 projects into the frame but must maintain an electrical clearance from, for example, the end windings. Because embodiments of the invention reduce the depth of the stiffener 436 (depth of braces 538) while maintaining the required electrical clearance, the overall frame length and, therefore, the distance between bearings on either side of the machine 110 is reduced. The embodiment of FIG. 8 shows the stiffener 436 on the back side of the bearing bracket 130 (on the inside of the machine). In alternate embodiments, the stiffener 436 may be on the opposite side (the side of the bearing bracket 130 facing away from the machine 110). In the embodiment of FIG. 8, radial braces 538 are connected to each other on both ends by braces 538 that form concentric arcs. In alternate embodiments, the angles of the braces 538 may be altered to some extent (e.g., vertical rather than radial braces 538 and straight rather than arced braces 538 or non-concentric arced braces 538). Although the embodiment of the stiffener 436 shown at FIG. 8 has arc-shaped braces 538 that exceed 180 degrees, it should be understood that the stiffener 436 including substantially arc-shaped braces 538 that connect substantially radial braces 538 provides enhanced stiffness even when used with other bracket designs such as, for example, the half-circle bearing bracket of previous designs.

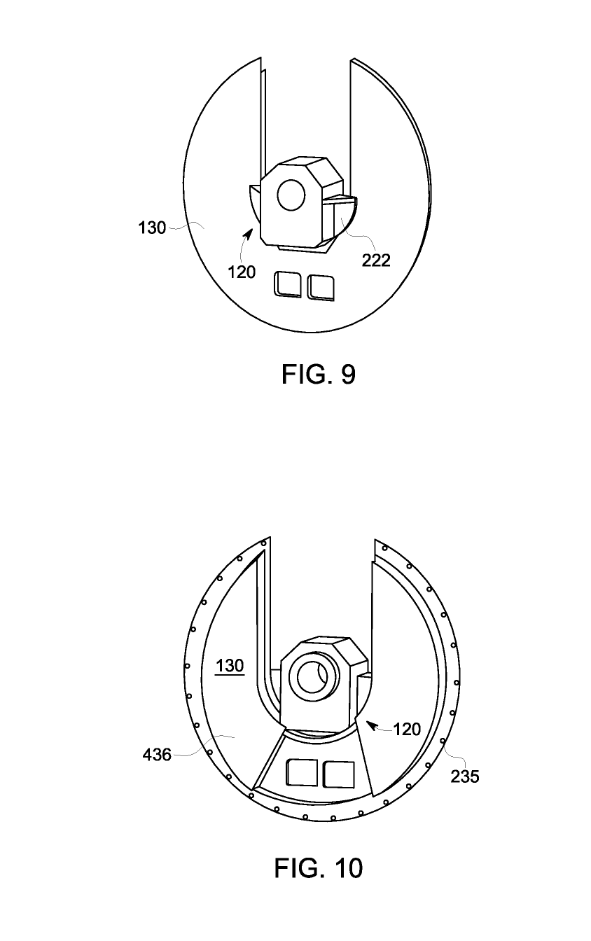

FIG. 9 is a perspective front view of a bearing bracket 130 according to a different embodiment of the invention. The bearing bracket 130 of the present embodiment has a cross-sectional shape similar to a circle with a slotted cutout. The shape of the cutout portion of the circle is that of an inner concentric circle with two vertical (rather than radial) lines, each extending from a different point on the perimeter of the inner concentric circle (rather than from the center), to the outer edge of the bearing bracket 130. The bearing housing 120 could slide into the slot in the bearing bracket 130. The slot edges could extend diagonally outward (rather than vertically) from the perimeter of the inner circle to create a larger slot than the one shown at FIG. 9.

Like the embodiment shown previously, the bearing bracket 130 shown at FIG. 9 may be used with a center flange 222 or an end flange 322 mounted bearing housing 120. In addition, the bearing bracket 130 may be formed integrally with the bearing housing 120 or as a separate part that is affixed to the bearing housing 120. The slotted shape of the cutout portion in the bearing bracket 130 of FIG. 9 allows easy access to the machine 110.

FIG. 10 is a perspective back view of the bearing bracket 130 according to the embodiment shown by FIG. 9. Because the bearing bracket 130 according to this embodiment, like the previous embodiment, has an increased area for the stiffener 436 (covers more than a half-circle, for example), the depth of the stiffener 436 (depth of braces 538 shown at FIG. 8) can be shallower and require less protrusion into the machine 110 while providing the same or greater stiffness to the bearing bracket 130 as conventional designs.

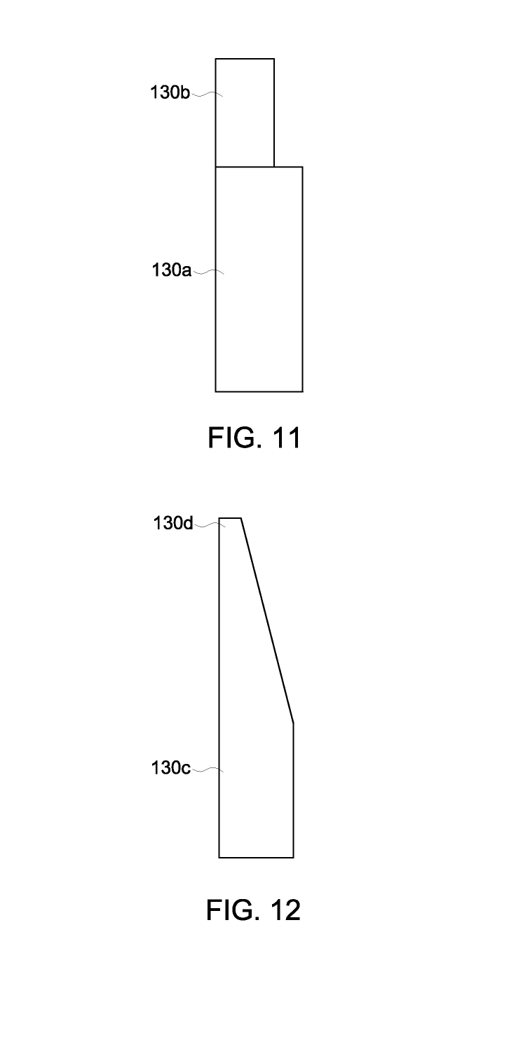

FIGS. 11 and 12 are perspective side views of the bearing bracket 130 according to embodiments of the invention. FIGS. 11 and 12 illustrate that, for any of the embodiments discussed above, the bearing bracket 130 may comprise multiple sectors of varying thicknesses. In the embodiment of FIG. 11, two distinct sectors 130a, 130b are shown with two different thicknesses. In the embodiment of FIG. 12, a taper from one thickness in a sector 130c of the bearing bracket 130 to another sector 130d is illustrated. Additionally, the multiple sectors may comprise different materials instead of or in addition to different thicknesses. For example, for the bearing bracket 130 shown at FIG. 3, the thickness of the bearing bracket 130 comprising the lower half-circle sector may be thicker (as in sector 130a of FIG. 11) or thinner than the sectors of the bearing bracket 130 extending above the half-circle sector (as in sector 130b of FIG. 11, for example). For example, those two sectors 130a, 130b may comprise different materials. The different sectors of the bearing bracket 130 may be integrally formed or affixed together such as by welding, for example, or by another known method. It should be understood that, in alternate embodiments, combinations of the above-discussed thickness and material variations among different sectors of the bearing bracket 130 according to any of the above-discussed embodiments are contemplated. Further, when multiple sectors are present in a bearing bracket 130, some of the sectors may be affixed while others are integrally formed.

While two specific embodiments of the bearing bracket 130 are detailed herein, this application contemplates any variation of the embodiments of the bearing bracket 130 that provides access to the machine while increasing angular span of the bearing bracket such that the stiffness-to-mass ratio is maintained or increased.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A bearing system for a machine, comprising:
a bearing housing configured to constrain motion of a part within the machine, the bearing housing having a substantially circular cross-sectional shape; and
a bearing bracket configured to secure the bearing housing to the machine, the bearing bracket formed to cover more than a half and less than all of the circular cross-sectional shape of the bearing housing, wherein a perimeter of the bearing bracket is a semi-circle.

2. The bearing system according to claim 1, wherein the bearing bracket comprises two or more sectors, and at least one of the two or more sectors differs in at least one of a thickness or a material composition from others of the two or more sectors.

3. The bearing system according to claim 2, wherein the at least one of the two or more sectors includes a reduced thickness, and a transition from a thickness of at least one other of the two or more sectors to the reduced thickness of the one of the two or more sectors is a tapering.

4. The bearing system according to claim 2, wherein the at least one of the two or more sectors includes a reduced thickness, and a transition from a thickness of at least one other of the two or more sectors to the reduced thickness of the one of the two or more sectors is abrupt.

5. The bearing system according to claim 2, wherein the two or more sectors are integrally formed.

6. The bearing system according to claim 2, wherein the two or more sectors are formed separately.

7. The bearing system according to claim 1, wherein the bearing housing and the bearing bracket are integrally formed.

8. The bearing system according to claim 1, wherein the bearing housing and the bearing bracket are formed as two separate parts.

9. The bearing system of claim 1, wherein the bearing housing is center flange mounted or end flange mounted.

10. The bearing system according to claim 1, wherein a cross-sectional shape of the bearing bracket is formed by two concentric arcs having a same central angle and being connected by segments of radial lines that define each end of the two concentric arcs.

11. (canceled)

12. The bearing system according to claim 1, wherein a cross-sectional shape of the bearing bracket is that of a circle with a slotted opening into which the bearing housing engages or attaches.

13. (canceled)

14. The bearing system according to claim 12, wherein the slotted opening comprises a concentric circle smaller than the circle with vertical lines, each extending from a different point on a perimeter of the concentric circle to a perimeter of the circle.

15. A bearing bracket supporting a bearing housing in a machine, the bearing bracket comprising:
material formed with a cross-sectional shape comprising two concentric semi-circular arcs having a same central angle and being connected by segments of radial lines that define each end of the semi-circular arcs, at least an outer one of the two concentric semi-circular arcs being greater than half of a full circle; and
a stiffener comprised of two or more braces in a first direction and alternating hollow portions, the two or more braces in the first direction being connected by a pair of braces in a second direction.

16. The bearing bracket according to claim 15, further comprising two or more sectors, wherein at least one of a thickness or a material forming at least one of the two or more sectors is different from a thickness or a material forming others of the two or more sectors.

17. The bearing bracket according to claim 16, wherein the at least one of the two or more sectors includes a reduced thickness, and a transition from the thickness of at least one other of the two or more sectors to the reduced thickness of the one of the two or more sectors is a tapering.

18. The bearing system according to claim 16, wherein the at least one of the two or more sectors includes a reduced thickness, and a transition from the thickness of at least one other of the two or more sectors to the reduced thickness of the one of the two or more sectors is abrupt.

19. The bearing system according to claim 16, wherein the two or more sectors are integrally formed.

20. The bearing system according to claim 16, wherein the two or more sectors are formed separately.

21. The bearing bracket according to claim 15, wherein one of the pair of braces in the second direction connects a first side of each of the two or more braces in the first direction, another of the pair of braces in the second direction connects a second side of each of the two or more braces in the first direction, the first side is closer to a smaller of the two concentric semi-circular arcs than a larger of the two concentric arcs, and the second side is closer to the larger of the two concentric arcs than the smaller of the two concentric semi-circular arcs.

22. (canceled)

23. The bearing bracket according to claim 15, wherein the bearing bracket is integrally formed with the bearing housing.

24. The bearing bracket according to claim 15, wherein the bearing bracket is configured to be used with the bearing housing being center flange mounted or end flange mounted.

25. A bearing bracket for affixing a bearing housing in a machine, the bearing bracket comprising:
material formed with a cross-sectional shape of a circle with a slot removed; and
a stiffener comprised of two or more braces in a first direction and alternating hollow portions, the two or more braces in the first direction being connected by a pair of braces in a second direction.

26. The bearing bracket according to claim 25, further comprising two or more sectors, wherein at least one of a thickness or a material forming at least one of the two or more sectors is different from a thickness or a material forming others of the two or more sectors.

27. The bearing bracket according to claim 26, wherein the at least one of the two or more sectors includes a reduced thickness, and a transition from the thickness of at least one other of the two or more sectors to the reduced thickness of the one of the two or more sectors is a tapering.

28. The bearing system according to claim 26, wherein the at least one of the two or more sectors includes a reduced thickness, and a transition from the thickness of at least one other of the two or more sectors to the reduced thickness of the one of the two or more sectors is abrupt.

29. The bearing system according to claim 26, wherein the two or more sectors are integrally formed.

30. The bearing system according to claim 26, wherein the two or more sectors are formed separately.

31. The bearing bracket according to claim 25, wherein one of the pair of braces in the second direction connects a first side of each of the two or more braces in the first direction, another of the pair of braces in the second direction connects a second side of each of the two or more braces in the first direction, the first side is closer to a smaller of the two concentric arcs than a larger of the two concentric arcs, and the second side is closer to the larger of the two concentric arcs than the smaller of the two concentric arcs.

32. (canceled)

33. The bearing bracket according to claim 25, wherein the bearing bracket is integrally formed with the bearing housing.

34. The bearing bracket according to claim 25, wherein the bearing bracket is configured to be used with the bearing housing being center flange mounted or end flange mounted.

35. The bearing bracket according to claim 25, wherein the slot comprises a concentric circle smaller than the circle with vertical lines, each extending from a different point on a perimeter of the concentric circle to the perimeter of the circle.
